(19) United States
(12) Patent Application Publication
(10) Pub. No.: US 2026/0014729 A1
(43) Pub. Date: Jan. 15, 2026

(54) ASEPTIC PINCHING DEVICE AND OPERATING METHOD THEREOF

(71) Applicant: CINTRADE ENTERPRISE, INC., New Taipei City (TW)

(72) Inventors: Yu-Ling LIU, New Taipei City (TW); Qian-Ci HUANG, New Taipei City (TW); Li-Hao TAI, New Taipei City (TW); Bo-Wen ZHAN, New Taipei City (TW)

(21) Appl. No.: 19/263,961

(22) Filed: Jul. 9, 2025

Related U.S. Application Data
(60) Provisional application No. 63/669,757, filed on Jul. 11, 2024.

(51) Int. Cl. B26D 7/01

(52) U.S. Cl. CPC B26D 7/01; B26D 2007/011; B26D 2007/013

(57) ABSTRACT

An aseptic pinching device includes two half components. Each one of the two half components has a base structure, a first buckle structure connected to a first side of the base structure, and a second buckle structure connected to a second side of the base structure opposite to the first side. The two half components are identical. One of the half components is configured to be flipped 180 degrees relative to the other such that one of the half components is brought toward the other to engage each other. A diagonal space is formed by the base structure of one of the half components and the base structure of the other, and the diagonal space is configured to accommodate a sleeve to pinch the sleeve between the two half components.

This application claims priority of U.S. Provisional Application No. 63/669,757 filed on 2024 Jul. 11 under 35 U.S.C. § 119(e), the entire contents of which are hereby incorporated by reference.

### BACKGROUND OF THE INVENTION

### (a) Field of the Invention

The present disclosure relates to an aseptic pinching device and an operating method of the aseptic pinching device, and it especially relates to the aseptic pinching device which has two identical half components such that one of the half components is flipped 180 degrees relative to the other of the half components to engage each other.

### (b) Description of the Prior Art

In medical environments or laboratories, the use of sleeves typically requires sterility, and cutting of the sleeves is performed by aseptic pinching and cutting devices. The traditional pinching and cutting devices typically secure the sleeve between a male component and a female component, such that the sleeve is pinched between the two components and then cut by a cutting element. However, these devices require two different components (the male component and the female component) to pinch and secure the sleeve. As a result, manufacturers must produce two separate molds to fabricate the components, which not only increases the manufacturing cost of the pinching device, but also causes inconvenience during component assembly for the user.

### SUMMARY OF THE INVENTION

One aspect of the present disclosure is an aseptic pinching device. The two half components have identical profiles, and one of the half components can be flipped 180 degrees relative to the other to engage each other such that the manufacturing cost of the components is reduced and the convenience during component assembly for the user is further improved.

According to an embodiment of the present disclosure, an aseptic pinching device includes two half components. Each one of the two half components has a base structure, a first buckle structure connected to a first side of the base structure, and a second buckle structure connected to a second side of the base structure opposite to the first side. The two half components are identical. One of the half components is configured to be flipped 180 degrees relative to the other of the half components such that one of the half components is brought toward the other of the half components to engage each other. A diagonal space is formed by the base structure of one of the half components and the base structure of the other of the half components, and the diagonal space is configured to accommodate a sleeve to pinch the sleeve between the two half components.

In one embodiment of the present disclosure, when one of the half components is flipped 180 degrees relative to the other of the half components to face each other, one of the half components is aligned with the other of the half components in a vertical direction.

In one embodiment of the present disclosure, the first buckle structure of the half component has a first buckle body and a buckle end portion disposed on the first buckle body, and the buckle end portion extends outward from the first buckle body.

In one embodiment of the present disclosure, the first buckle body of the first buckle structure of the half component has an L-shaped profile, and the first buckle body faces away from the base structure.

In one embodiment of the present disclosure, the second buckle structure of the half component has a second buckle body and a buckle recess disposed on the second buckle body, and the buckle recess of one of the half components is configured to receive the buckle end portion of the other of the half components to position the two half components.

In one embodiment of the present disclosure, the second buckle body of the second buckle structure of the half component has an L-shaped profile, and the second buckle body faces toward the base structure.

In one embodiment of the present disclosure, a connecting space is formed between the second buckle body of the second buckle structure and the base structure of the half component, and the connecting space of one of the half components is configured to receive the first buckle body of the other of the half components to position the two half components.

In one embodiment of the present disclosure, the first buckle structure of the half component has a connecting groove facing away from the buckle end portion, the second buckle structure of the half component has a connecting element facing toward the buckle recess, and the connecting groove of one of the half components is configured to receive the connecting element of the other of the half components to position the two half components.

Another aspect of the present disclosure is an operating method of an aseptic pinching device. The two half components have identical profiles, and one of the half components can be flipped 180 degrees relative to the other to engage each other such that the manufacturing cost of the components is reduced and the convenience during component assembly for the user is further improved.

According to an embodiment of the present disclosure, an operating method of an aseptic pinching device includes: providing two half components, wherein each one of the two half components has a base structure, a first buckle structure disposed on a first side of the base structure, and a second buckle structure disposed on a second side of the base structure opposite to the first side, and the two half components are identical; and flipping one of the half components 180 degrees relative to the other of the half components such that one of the half components is brought toward the other of the half components to engage each other, wherein a diagonal space is formed by the base structure of one of the half components and the base structure of the other of the half components, and the diagonal space is configured to accommodate a sleeve to pinch the sleeve between the two half components.

In one embodiment of the present disclosure, when one of the half components is flipped 180 degrees relative to the other of the half components to face each other, one of the half components is aligned with the other of the half components in a vertical direction.

In the embodiments of the present disclosure, the aseptic pinching device includes the two half components, and the two half components have identical profiles. One of the half components can be flipped 180 degrees relative to the other such that one of the half components is brought toward the other to engage each other. The diagonal space is formed by the base structures of the two half components to secure the sleeve within the diagonal space. It is noted that the structural configuration of the aseptic pinching device does not require two different components, such as a male component and a female component as in traditional pinching devices. Instead, the sleeve can be pinched within the diagonal space by using only two identical half components. As a result, the aseptic pinching device using the two identical half components can reduce the manufacturing cost of the components and further improve the convenience during component assembly for the user.

To enable a further understanding of said objectives, structures, characteristics, and effects, as well as the technology and methods used in the present invention and effects achieved, a brief description of the drawings is provided below followed by a detailed description of the preferred embodiments.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a perspective view of an aseptic pinching device according to an embodiment of the present disclosure.

FIG. 2 is a side view of the aseptic pinching device of FIG. 1.

FIG. 3 is a perspective view of a half component according to an embodiment of the present disclosure.

FIG. 4 is a top view of the half component of FIG. 3.

FIG. 5 is a cross-sectional view of the half component of FIG. 4 along the line segment A-A.

FIG. 6 is a perspective view showing two half components in parallel abutment according to an embodiment of the present disclosure.

FIG. 7 is a flow chart illustrating an operating method of an aseptic pinching device according to an embodiment of the present disclosure.

FIG. 8 and FIG. 9 are schematic views illustrating that the aseptic pinching device is operated according to some embodiments of the present disclosure.

FIG. 10 is a schematic view illustrating that the aseptic pinching device is operated according to another embodiment of the present disclosure.

### DETAILED DESCRIPTION OF THE PREFERRED EMBODIMENTS

The following disclosure provides many different embodiments, or examples, for implementing different features of the provided subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Spatially relative terms, such as “beneath,” “below,” “lower,” “above,” “upper,” “front,” “back” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

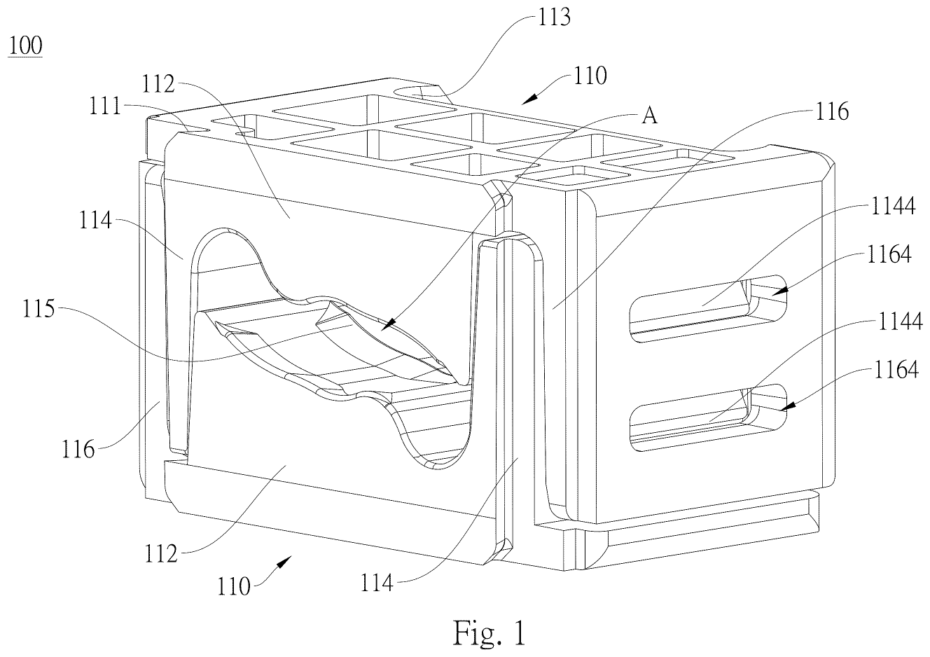

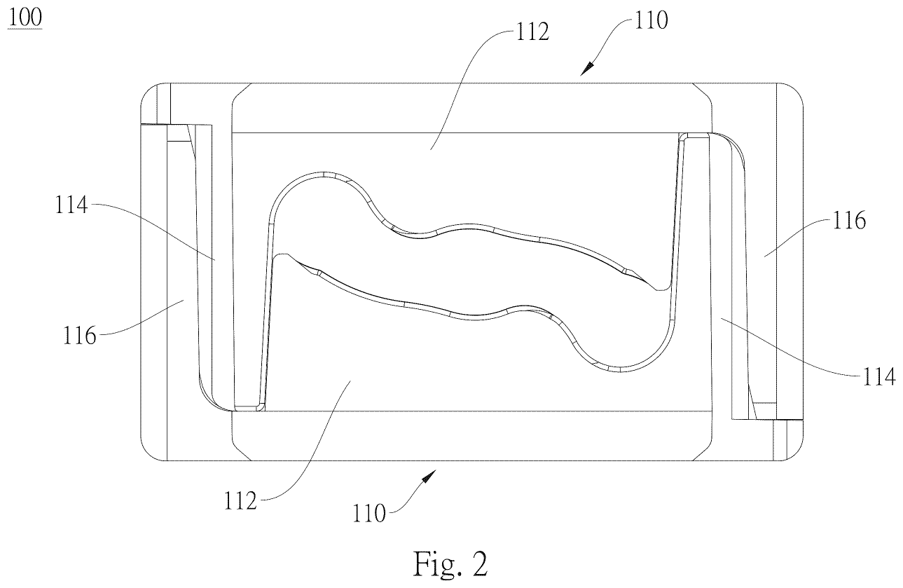

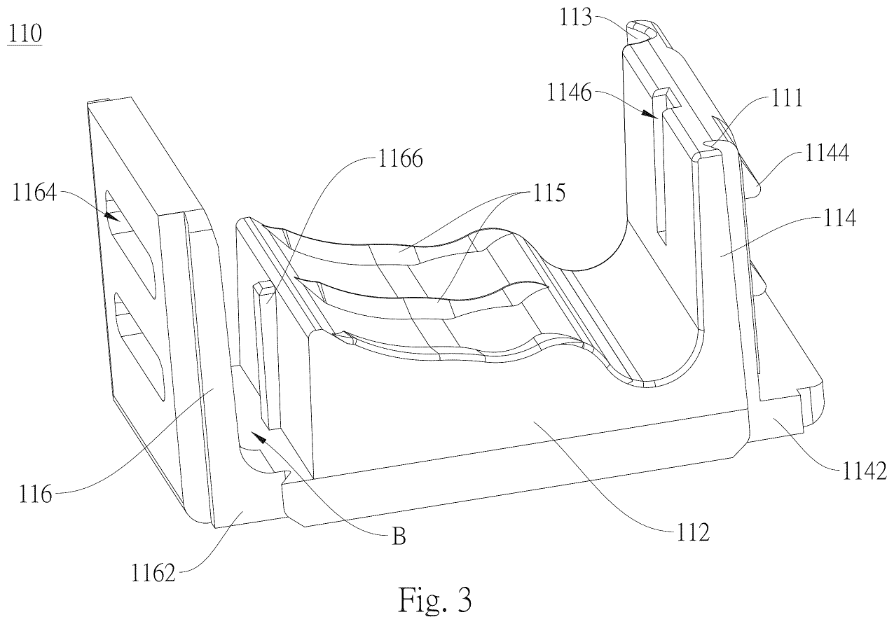

Please refer to FIG. 1 to FIG. 3, FIG. 1 is a perspective view of an aseptic pinching device 100 according to an embodiment of the present disclosure, FIG. 2 is a side view of the aseptic pinching device 100 of FIG. 1, and FIG. 3 is a perspective view of a half component 110 according to an embodiment of the present disclosure. In FIG. 1 to FIG. 3, the aseptic pinching device 100 includes two half components 110. Each half component 110 has a base structure 112, a first buckle structure 114 connected to a first side of the base structure 112, and a second buckle structure 116 connected to a second side of the base structure 112 opposite to the first side. For example, the first buckle structure 114 and the second buckle structure 116 of the half component 110 are located on opposite sides of the base structure 112. In some embodiments, the number of the half components 110 of the aseptic pinching device 100 is an even number, so the number of the half components 110 is not limited in this regard.

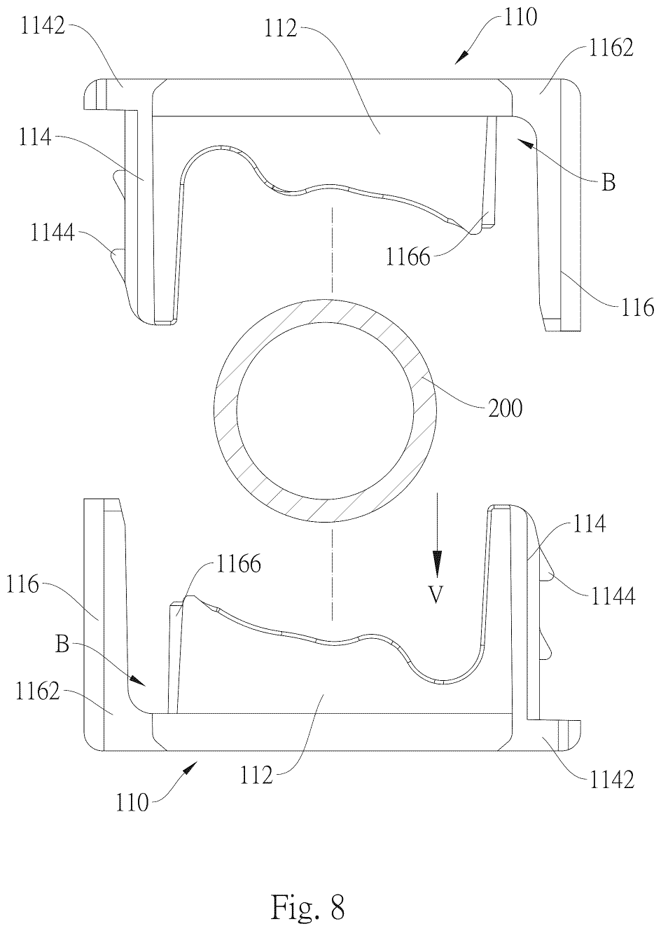

It is noted that the two half components 110 are identical and have identical profiles. In other words, the aseptic pinching device 100 can be assembled by only two identical half components 110. Additionally, one of the half components 110 can be flipped 180 degrees relative to the other half component 110 such that the two half components 110 are brought toward to engage each other. In some embodiments, a diagonal space A is formed by the base structure 112 of one of the half components 110 and the base structure 112 of the other half component 110. That is, the diagonal space A is formed by the base structures 112 of the two half components 110. The diagonal space A is configured to accommodate a sleeve 200 (will be described in FIG. 8) so that the sleeve 200 can be pinched between the two half components 110.

In some embodiments, the first buckle structure 114 of the half component 110 includes a first buckle body 1142 and a buckle end portion 1144 disposed on the first buckle body 1142. The buckle end portion 1144 extends outward from the first buckle body 1142. Furthermore, the second buckle structure 116 of the half component 110 includes a second buckle body 1162 and a buckle recess 1164 disposed on the second buckle body 1162. Specifically, the buckle recess 1164 of the second buckle structure 116 of one of the half components 110 is configured to receive the buckle end portion 1144 of the first buckle structure 114 of the other half component 110 to buckle and position the two half components 110 as illustrated in FIG. 1.

In some embodiments, the first buckle body 1142 of the first buckle structure 114 of the half component 110 has an L-shaped profile, and the first buckle body 1142 faces away from the base structure 112 of the half component 110. Additionally, the second buckle body 1162 of the second buckle structure 116 of the half component 110 also has an L-shaped profile, and the second buckle body 1162 faces toward the base structure 112 of the half component 110. That is, the second buckle body 1162 of the second buckle structure 116 faces the base structure 112 of the half component 110.

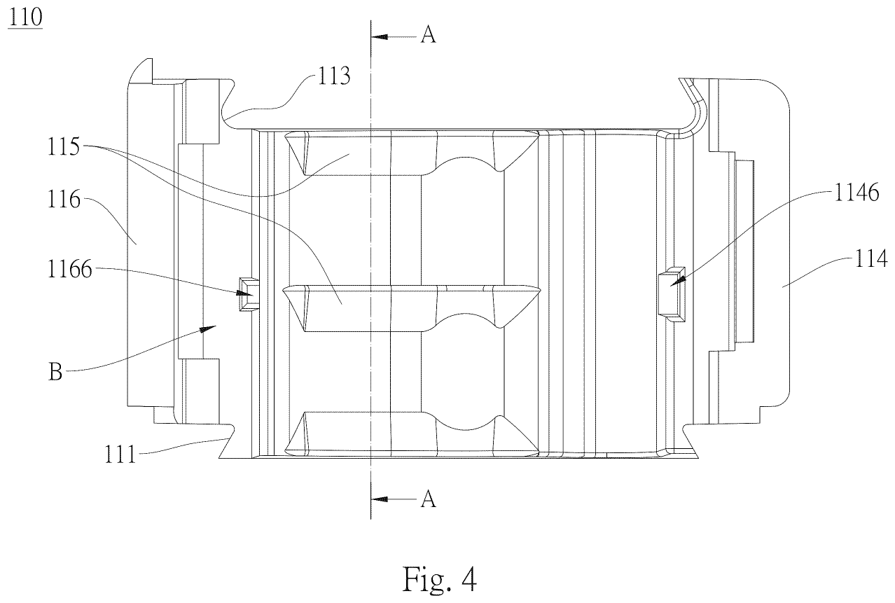

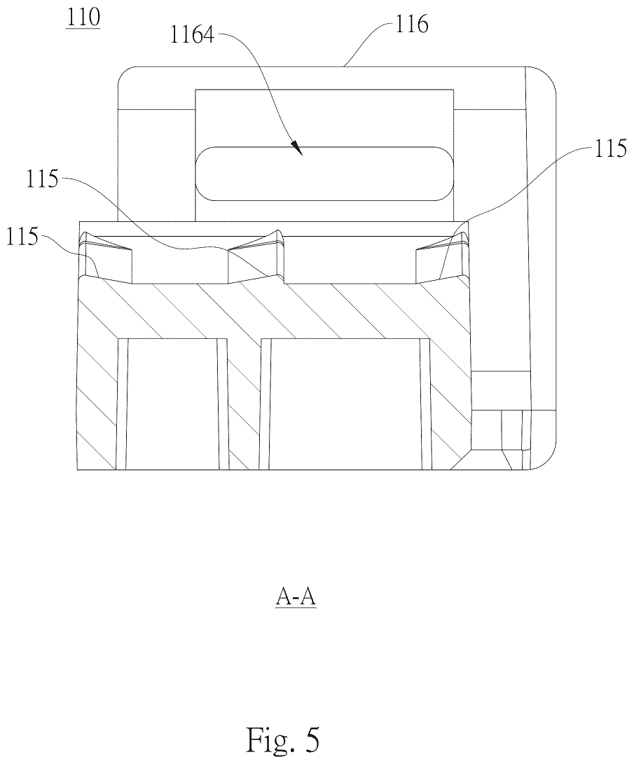

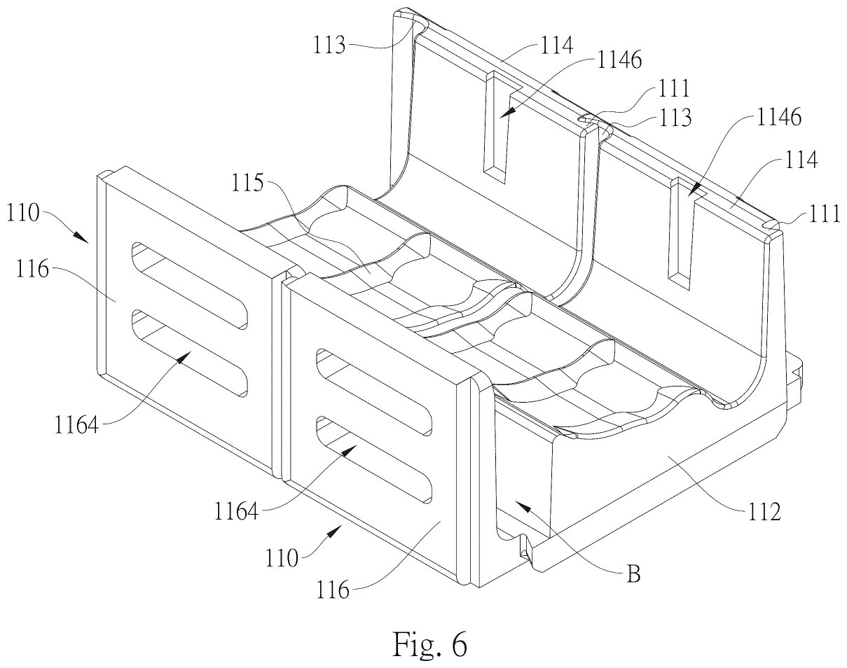

Please refer to FIG. 4 to FIG. 6, FIG. 4 is a top view of the half component 110 of FIG. 3, FIG. 5 is a cross-sectional view of the half component 110 of FIG. 4 along the line segment A-A, and FIG. 6 is a perspective view showing two half components 110 in parallel abutment according to an embodiment of the present disclosure. In FIG. 4 to FIG. 6, the base structure 112 of the half component 110 has a protruding end 115. The protruding end 115 of the base structure 112 of the half component 110 is configured to contact a sleeve 200 (will be described in FIG. 8). In addition, opposite two ends of the half component 110 respectively have an abutting end 111 and an abutting groove 113. The two horizontally arranged half components 110 may abut each other through the abutting ends 111 and the abutting grooves 113. That is, the multiple half components 110 can be connected in series through the engagement between the abutting ends 111 and the abutting grooves 113.

In some embodiments, a connecting space B is formed between the second buckle body 1162 of the second buckle structure 116 and the base structure 112 of the half component 110. The connecting space B of one of the two half components 110 is configured to receive the first buckle body 1142 of the other half component 110 to position the two half components 110. Furthermore, the first buckle structure 114 of the half component 110 has a connecting groove 1146 facing away from the buckle end portion 1144, and the second buckle structure 116 of the half component 110 has a connecting element 1166 facing toward the buckle recess 1164. The connecting groove 1146 of one of the half components 110 is configured to receive the connecting element 1166 of the other half component 110 to position the two half components 110.

In the following description, an operating method of an aseptic pinching device will be described. It is to be noted that the connection relationship of the aforementioned elements will not be repeated.

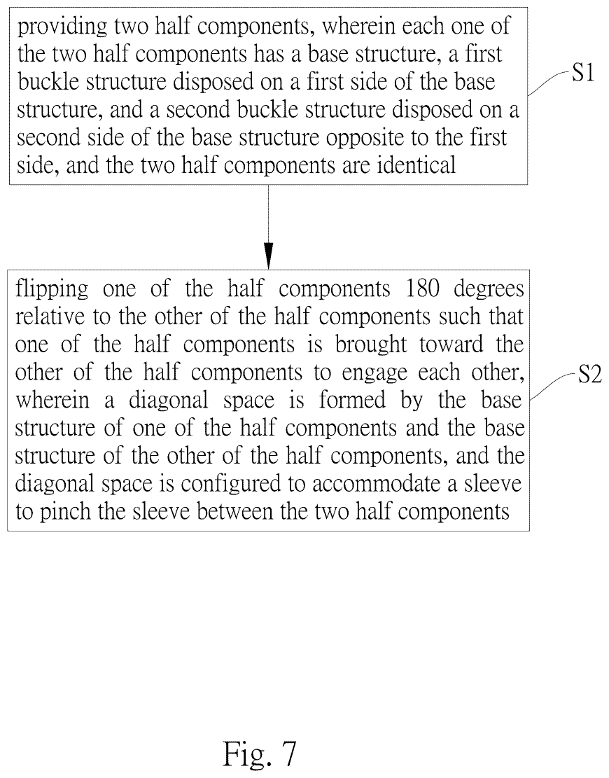

Please refer to FIG. 7, FIG. 7 is a flowchart illustrating an operating method of an aseptic pinching device according to an embodiment of the present disclosure. The operating method of the aseptic pinching device includes steps as outlined below. In step (a) S1, two half components are provided. Each one of the two half components has a base structure, a first buckle structure disposed on a first side of the base structure, and a second buckle structure disposed on a second side of the base structure opposite to the first side, and the two half components are identical. In step (b) S2, one of the half components is flipped 180 degrees relative to the other of the half components such that one of the half components is brought toward the other of the half components to engage each other. A diagonal space is formed by the base structure of one of the half components and the base structure of the other of the half components, and the diagonal space is configured to accommodate a sleeve to pinch the sleeve between the two half components. In the following description, the aforementioned steps will be described in detail.

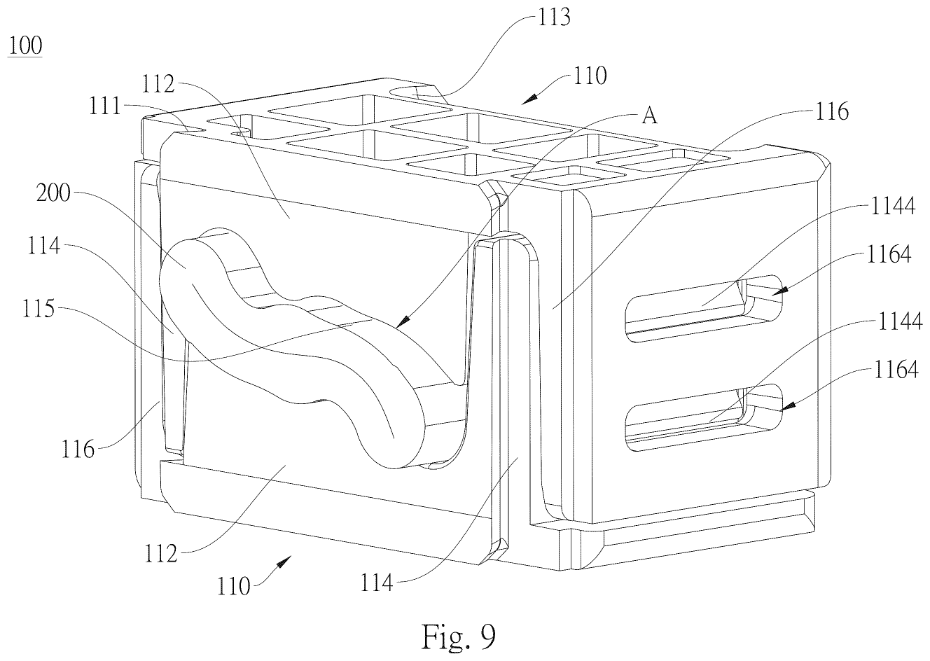

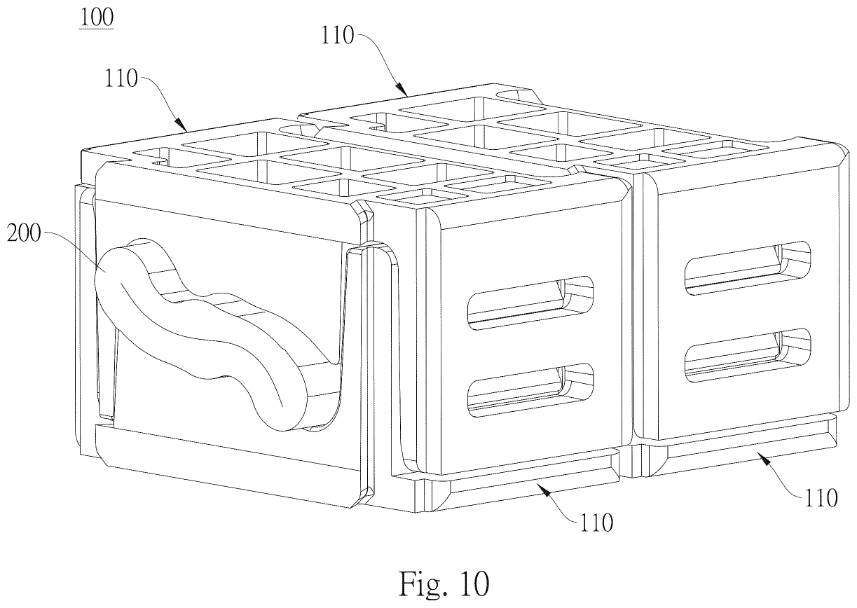

Please refer to FIG. 8 to FIG. 10, FIG. 8 and FIG. 9 are schematic views illustrating that the aseptic pinching device 100 is operated according to some embodiments of the present disclosure, and FIG. 10 is a schematic view illustrating that the aseptic pinching device 100 is operated according to another embodiment of the present disclosure. In FIG. 8 to FIG. 9, first, the two half components 110 may be provided. Each one of the two half components 110 has a base structure 112, a first buckle structure 114 disposed on a first side of the base structure 112, and a second buckle structure 116 disposed on a second side of the base structure 112 opposite to the first side. The two half components 110 are identical and have identical profiles. The sleeve 200 used in medical environments or laboratories may be provided. Next, one of the half components 110 is flipped 180 degrees relative to the other of the half components 110 such that one of the half components 110 is brought toward the other of the half components 110 to engage each other. Specifically, when one of the half components 110 is flipped 180 degrees relative to the other of the half components 110 to face each other, one of the half components 110 is aligned with the other of the half components 110 in a vertical direction V. Additionally, the base structure 112 of one of the half components 110 faces toward the base structure 112 of the other of the half components 110 such that the diagonal space A is formed. The diagonal space A is configured to accommodate the sleeve 200 so that the sleeve 200 is pinched between the two half components 110. In FIG. 10, the difference between the embodiment of FIG. 10 and the embodiment of FIG. 9 is that the aseptic pinching device 100 shown in FIG. 10 includes the four half components 110. The four half components 110 are arranged in two horizontal pairs such that all the four half components 110 simultaneously pinch the sleeve 200. This configuration enhances the positioning stability between the half components 110 and the sleeve 200 such that the sleeve 200 may be cut by a cutting element. In addition, the aseptic pinching device 100 shown in FIG. 10 has a first pair of the half components 110 (the two half components 110 at left side) and a second pair of the half components 110 (the two half components 110 at right side) are configured to pinch opposite ends of the sleeve 200. After the sleeve 200 is cut, the first pair of the half components 110 pinches a left end of the sleeve 200, and the second pair of the half components 110 pinches a right end of the sleeve 200. Therefore, both cut ends of the sleeve 200 still remain in an aseptic state.

In summary, the aseptic pinching device 100 includes the two half components 110, and the two half components 110 have identical profiles. One of the half components 110 can be flipped 180 degrees relative to the other such that one of the half components 110 is brought toward the other to engage each other. The diagonal space A is formed by the base structures 112 of the two half components 110 to secure the sleeve 200 within the diagonal space A. It is noted that the structural configuration of the aseptic pinching device 100 does not require two different components, such as a male component and a female component as in traditional pinching devices. Instead, the sleeve 200 can be pinched within the diagonal space A by using only two identical half components 110. As a result, the aseptic pinching device 100 using the two identical half components 110 can reduce the manufacturing cost of the components and further improve the convenience during component assembly for the user.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. An aseptic pinching device, comprising:
two half components, each having a base structure, a first buckle structure connected to a first side of the base structure, and a second buckle structure connected to a second side of the base structure opposite to the first side, wherein the two half components are identical, and one of the half components is configured to be flipped 180 degrees relative to the other of the half components such that one of the half components is brought toward the other of the half components to engage each other,
wherein a diagonal space is formed by the base structure of one of the half components and the base structure of the other of the half components, and the diagonal space is configured to accommodate a sleeve to pinch the sleeve between the two half components.

2. The aseptic pinching device according to claim 1, wherein when one of the half components is flipped 180 degrees relative to the other of the half components to face each other, one of the half components is aligned with the other of the half components in a vertical direction.

3. The aseptic pinching device according to claim 1, wherein the first buckle structure of the half component has a first buckle body and a buckle end portion disposed on the first buckle body, and the buckle end portion extends outward from the first buckle body.

4. The aseptic pinching device according to claim 3, wherein the first buckle body of the first buckle structure of the half component has an L-shaped profile, and the first buckle body faces away from the base structure.

5. The aseptic pinching device according to claim 3, wherein the second buckle structure of the half component has a second buckle body and a buckle recess disposed on the second buckle body, and the buckle recess of one of the half components is configured to receive the buckle end portion of the other of the half components to position the two half components.

6. The aseptic pinching device according to claim 5, wherein the second buckle body of the second buckle structure of the half component has an L-shaped profile, and the second buckle body faces toward the base structure.

7. The aseptic pinching device according to claim 5, wherein a connecting space is formed between the second buckle body of the second buckle structure and the base structure of the half component, and the connecting space of one of the half components is configured to receive the first buckle body of the other of the half components to position the two half components.

8. The aseptic pinching device according to claim 5, wherein the first buckle structure of the half component has a connecting groove facing away from the buckle end portion, the second buckle structure of the half component has a connecting element facing toward the buckle recess, and the connecting groove of one of the half components is configured to receive the connecting element of the other of the half components to position the two half components.

9. An operating method of an aseptic pinching device, comprising steps of:
a) providing two half components, wherein each one of the two half components has a base structure, a first buckle structure disposed on a first side of the base structure, and a second buckle structure disposed on a second side of the base structure opposite to the first side, and the two half components are identical; and
b) flipping one of the half components 180 degrees relative to the other of the half components such that one of the half components is brought toward the other of the half components to engage each other, wherein a diagonal space is formed by the base structure of one of the half components and the base structure of the other of the half components, and the diagonal space is configured to accommodate a sleeve to pinch the sleeve between the two half components.

10. The operating method of the aseptic pinching device according to claim 9, wherein when one of the half components is flipped 180 degrees relative to the other of the half components to face each other, one of the half components is aligned with the other of the half components in a vertical direction.
